(19) United States
(12) Patent Application Publication
(10) Pub. No.: US 2017/0008365 A1
(43) Pub. Date: Jan. 12, 2017

(54) STABILIZER BUSHING

(71) Applicant: TOYOTA JIDOSHA KABUSHIKI KAISHA, Toyota-shi (JP)

(72) Inventors: Masahiro TSUKAMOTO, Toyota-shi (JP); Toru NEICHI, Okazaki-shi (JP); Satoshi UCHIDA, Toyota-shi (JP)

(73) Assignee: TOYOTA JIDOSHA KABUSHIKI KAISHA, Toyota-shi (JP)

(21) Appl. No.: 15/155,834

(22) Filed: May 16, 2016

(30) Foreign Application Priority Data
Jul. 8, 2015 (JP) 2015-136685

(51) Int. Cl. B60G 21/055; F16F 1/373

(52) U.S. Cl. CPC B60G 21/0551; F16F 1/3732; B60G 2204/418; B60G 2204/4302; B60G 2204/41

(57) ABSTRACT

A stabilizer bushing includes a holding hole, a vehicle-body facing surface, an outer surface having a U-shape, and at least one separation surface extending from an inner circumferential surface of the holding hole to the outer surface. Each of the at least one separation surface has a pressing force generating surface located nearer to the vehicle-body facing surface than a particular plane in a state in which the stabilizer bushing is mounted on a vehicle-body-side mount surface of a vehicle-body-side component. The particular plane has a central axis of the holding hole and is parallel with the vehicle-body-side mount surface. The pressing force generating surface has a holding-hole-side end portion and an outer-surface-side end portion. The pressing force generating surface is inclined so as to be farther from the vehicle-body-side mount surface at the outer-surface-side end portion than at the holding-hole-side end portion.

### CROSS REFERENCE TO RELATED APPLICATION

The present application claims priority from Japanese Patent Application No. 2015-136685, which was filed on Jul. 8, 2015, the disclosure of which is herein incorporated by reference in its entirety.

### BACKGROUND

Technical Field

The following disclosure relates to a stabilizer bushing used for mounting of a stabilizer bar on a vehicle body.

Description of the Related Art

Patent Document 1 (Japanese Patent Application Publication No. 2005-319850) discloses a stabilizer bushing (hereinafter simply referred to as “bushing”) including: a holding hole for holding a stabilizer bar; and a dividing surface as a separation surface extending from an inner circumferential surface of the holding hole to an outer surface of the bushing. The dividing surface is inclined so as to be nearer to a vehicle-body-side component at a portion of the dividing surface near the outer surface of the bushing than at a portion of the dividing surface near the inner circumferential surface of the holding hole.

### SUMMARY

Accordingly, an aspect of the disclosure relates to improvement of a stabilizer bushing having at least one separation surface for suppressing separation of the stabilizer bushing from the stabilizer bar due to a compressive force.

In one aspect of the disclosure, a stabilizer bushing has a pressing force generating surface having at least one separation surface each inclined so as to be farther from a vehicle-body-side component at an end portion of the separation surface near an outer surface of the bushing than at an end portion of the separation surface near a holding hole of the bushing. In the case where a stabilizer bar and the bushing are bonded to each other with adhesive, for example, a compressive force (which may be referred to as “preload”) is in some case applied to the bushing in a direction perpendicular to the vehicle-body-side mount surface after the stabilizer bar is held in the holding hole with adhesive and inserted in a bracket. In this case, a vertical stress directed toward the outer surface acts on the dividing surface in the bushing disclosed in Patent Document 1. In contrast, a vertical stress directed toward the stabilizer bar acts on the pressing force generating surface of the present bushing. This construction can suppress separation of the bushing from the stabilizer bar in the case where the compressive force is applied to the bushing. It is noted that the vertical stress is an internal force acting on a certain surface in a unit area in a direction perpendicular to the certain direction.

### CLAIMABLE INVENTIONS

There will be described inventions recognized to be claimable in the present disclosure and features of the inventions.

(1) A stabilizer bushing,

wherein the stabilizer bushing is formed with a holding hole extending in an axial direction and is configured to hold a stabilizer bar in the holding hole,

wherein the stabilizer bushing is to be mounted on a vehicle-body-side mount surface of a vehicle-body-side component,

wherein the stabilizer bushing comprises:

a vehicle-body facing surface opposed to the vehicle-body-side mount surface;

an outer surface having a U-shape in cross section perpendicular to the axial direction; and

at least one separation surface extending from an inner circumferential surface of the holding hole to the outer surface,

wherein each of the at least one separation surface comprises a pressing force generating surface located nearer to the vehicle-body facing surface than a particular plane in a bushing mounted state in which the stabilizer bushing is mounted on the vehicle-body-side mount surface,

wherein the particular plane comprising a central axis of the holding hole and is parallel with the vehicle-body-side mount surface in the bushing mounted state,

wherein the pressing force generating surface comprising a holding-hole-side end portion and an outer-surface-side end portion in the bushing mounted state,

wherein the holding-hole-side end portion is nearer to the holding hole than the outer-surface-side end portion, and the outer-surface-side end portion is nearer to the outer surface than the holding-hole-side end portion in the bushing mounted state, and

wherein the pressing force generating surface is inclined so as to be farther from the vehicle-body-side mount surface at the outer-surface-side end portion than at the holding-hole-side end portion in the bushing mounted state.

The pressing force generating surface may be flat or curved. Likewise, the vehicle-body facing surface may be flat or curved. The vehicle-body facing surface is in some case held in direct contact with the vehicle-body-side mount surface and in another case held in contact with a base provided between the vehicle-body-side component and the bushing in the state in which the stabilizer bar is mounted on the vehicle-body-side component, for example.

At least a portion of each of the at least one separation surface has the pressing force generating surface. Each of the at least one separation surface may be constituted by only the pressing force generating surface and may have not only the pressing force generating surface but also a surface different from the pressing force generating surface (for example, a surface different from the pressing force generating surface in direction of inclination), for example. That is, the holding-hole-side end portion is located on the inner circumferential surface of the holding hole in some case and spaced apart from the inner circumferential surface in another case, while the outer-surface-side end portion is located on the outer surface in some case and located inside the outer surface in another case.

(2) The stabilizer bushing according to the above form (1), wherein the pressing force generating surface is located nearer to the inner circumferential surface of the holding hole than the outer surface.

The pressing force generating surface is preferably provided at a position at which the pressing force generating surface presses the bushing against the stabilizer bar well.

(3) The stabilizer bushing according to the above form (1) or (2), wherein the holding-hole-side end portion of the pressing force generating surface is spaced apart from the inner circumferential surface of the holding hole.

(4) The stabilizer bushing according to any one of the above forms (1) through (3), wherein each of the at least one separation surface comprises a rising surface located nearer to the inner circumferential surface of the holding hole than the pressing force generating surface.

The rising surface may extend parallel with a direction in which a compressive force is applied, for example. In this construction, a considerably small vertical stress acts on the rising surface. The rising surface may extend substantially along a central plane extending through the central axis of the holding hole. In this construction, the vertical stress acts in a direction of tangent to the inner circumferential surface of the holding hole at a position at which the inner circumferential surface intersects the rising surface. Thus, it is possible to suppress separation of the bushing from the stabilizer bar when compared with a construction in which the vertical stress acts toward the outer surface.

(5) The stabilizer bushing according to the above form (4), wherein the holding-hole-side end portion of the rising surface is located on the inner circumferential surface of the holding hole at such a position that a central angle between (i) a plane connecting between the holding-hole-side end portion of the rising surface and the central axis of the holding hole and (ii) a plane comprising the central axis of the holding hole and parallel with the vehicle-body-side mount surface is a set angle.

An area of contact between the stabilizer bar and a portion of the bushing which is located on opposite side of the separation surface from the vehicle-body facing surface is larger in the case where the set angle θ is large than in the case where the set angle θ is small.

(6) The stabilizer bushing according to any one of the above forms (1) through (5),

wherein each of the at least one separation surface comprises an outside pressing force generating surface located nearer to the outer surface than an inside pressing force generating surface as the pressing force generating surface,

wherein the outside pressing force generating surface comprises a holding-hole-side end portion and an outer-surface-side end portion,

wherein the holding-hole-side end portion of the outside pressing force generating surface is nearer to the holding hole than the outer-surface-side end portion of the outside pressing force generating surface, and the outer-surface-side end portion of the outside pressing force generating surface is nearer to the outer surface than the holding-hole-side end portion of the outside pressing force generating surface, and

wherein the outside pressing force generating surface is inclined so as to be nearer to the vehicle-body-side mount surface at the outer-surface-side end portion of the outside pressing force generating surface than at the holding-hole-side end portion of the outside pressing force generating surface.

Since the vertical stress directed toward the outer surface acts on the outside pressing force generating surface, the bushing can be pressed against the bracket well.

(7) The stabilizer bushing according to any one of the above forms (1) through (6), wherein the stabilizer bushing comprises:

two separation surfaces as the at least one separation surface; and

two partial bushings each having a shape determined by the two separation surfaces.

(8) The stabilizer bushing according to any one of the above forms (1) through (7), wherein a normal line to the vehicle-body-side mount surface extends in a direction intersecting an up and down direction of a vehicle.

In the case where the bushing is mounted on a vehicle-body-side mount surface in a state in which the normal line thereto extends in the up and down direction, the separation surface may extend in a front and rear direction (a longitudinal direction) of the vehicle. In the case where a compressive force in a direction parallel with the normal line is applied to the bushing, a direction of a vertical stress that acts on the separation surface extending in the front and rear direction is a direction of tangent to the inner circumferential surface of the holding hole at a position at which the inner circumferential surface intersects the separation surface, making it difficult for the bushing to be separated from the stabilizer bar.

In contrast, if, as illustrated in FIG. 3, the separation surface is provided along a vertical central plane fz in the case where the bushing is mounted on the vehicle-body-side mount surface in a state in which the normal line thereto extends in the front and rear direction, for example, a force due to a twist of the stabilizer bar may deform the separation surface, which may make it impossible to exhibit functions of the stabilizer bar well. To solve this problem, in the stabilizer bushing according to this form, the separation surface is designed such that the bushing is not easily separated from the stabilizer bar due to the compressive force applied in the direction parallel with the normal line, and it is possible to exhibit the functions of the stabilizer bar in the case where the bushing is mounted on the vehicle-body-side mount surface in a state in which the normal line thereto extends in a direction intersecting the up and down direction.

(9) The stabilizer bushing according to any one of the above forms (1) through (8), wherein the pressing force generating surface is inclined in a state in which a vertical stress having a component directed toward the central axis of the holding hole acts on the pressing force generating surface when a compressive force is applied in a direction perpendicular to the vehicle-body-side mount surface.

(10) A stabilizer bushing,

wherein the stabilizer bushing is formed with a holding hole extending in an axial direction and is configured to hold a stabilizer bar in the holding hole,

wherein the stabilizer bushing is to be mounted on a vehicle-body-side mount surface of a vehicle-body-side component,

wherein the stabilizer bushing comprises at least one separation surface each extending from an inner circumferential surface of the holding hole to an outer surface of the stabilizer bushing,

wherein each of the at least one separation surface comprises a pressing force generating surface inclined in a state in which a vertical stress having a component directed toward a central axis of the holding hole acts on the pressing force generating surface when a compressive force is applied in a direction perpendicular to the vehicle-body-side mount surface in a bushing mounted state in which the stabilizer bushing is mounted on the vehicle-body-side mount surface, and

wherein the pressing force generating surface comprises a holding-hole-side end portion and an outer-surface-side end portion in the bushing mounted state,

wherein the holding-hole-side end portion is nearer to the holding hole than the outer-surface-side end portion, and the outer-surface-side end portion is nearer to the outer surface than the holding-hole-side end portion in the bushing mounted state, and

wherein the holding-hole-side end portion is spaced apart from the inner circumferential surface of the holding hole.

In the bushing according to this form, the pressing force generating surface extends from the holding-hole-side end portion spaced apart from the inner circumferential surface of the holding hole. In the bushing disclosed in Patent Document 1, in contrast, the dividing surface extends from the inner circumferential surface of the holding hole. The bushing according to this form and the bushing disclosed in Patent Document 1 differs from each other in this point. In the bushing according to this form, a portion of the bushing near the holding-hole-side end portion can be pressed against the stabilizer bar well.

The stabilizer bushing according to this form may incorporate the technical feature according to any one of the above forms (1) through (9).

(11) The stabilizer bushing according to the above form (10),

wherein a central plane extends through the central axis of the holding hole and a portion of the pressing force generating surface,

wherein the holding-hole-side end portion is located nearer to the vehicle-body facing surface than the central plane, and

wherein the outer-surface-side end portion is located on an opposite side of the central plane from the vehicle-body facing surface.

One of the holding-hole-side end portion and the outer-surface-side end portion of the pressing force generating surface is located on the central plane in some case. In the case where the holding-hole-side end portion is located on the central plane, the outer-surface-side end portion is located nearer to a top of the bushing than the central plane. In the case where the outer-surface-side end portion is located on the central plane, the holding-hole-side end portion is located nearer to the vehicle-body facing surface than the central plane.

A line segment corresponding to the pressing force generating surface may be positioned on a line extending not through a central point corresponding to the central axis of the holding hole in cross section perpendicular to the axis of the bushing. In other words, the line segment corresponding to the pressing force generating surface may be positioned on a line connecting between a point on an outline of the outer surface and a point spaced apart from the central point of the holding hole and located on a side of the central point of the holding hole which is nearer to a line corresponding to the vehicle-body-side mount surface.

(12) A stabilizer bushing,

wherein the stabilizer bushing is formed with a holding hole extending in an axial direction and is configured to hold a stabilizer bar in the holding hole,

wherein the stabilizer bushing is to be mounted on a vehicle-body-side mount surface of a vehicle-body-side component,

wherein the stabilizer bushing comprises:

a vehicle-body facing surface opposed to the vehicle-body-side mount surface;

an outer surface having a U-shape in cross section perpendicular to the axial direction; and

at least one separation surface extending from an inner circumferential surface of the holding hole to the outer surface,

wherein each of the at least one separation surface comprises a top-side pressing force generating surface located on an opposite side of a particular plane from the vehicle-body facing surface in a bushing mounted state in which the stabilizer bushing is mounted on the vehicle-body-side mount surface,

wherein the particular plane comprising a central axis of the holding hole and is parallel with the vehicle-body-side mount surface in the bushing mounted state,

wherein the top-side pressing force generating surface comprising a holding-hole-side end portion and an outer-surface-side end portion in the bushing mounted state,

wherein the holding-hole-side end portion is nearer to the holding hole than the outer-surface-side end portion, and the outer-surface-side end portion is nearer to the outer surface than the holding-hole-side end portion in the bushing mounted state, and

wherein the top-side pressing force generating surface is inclined so as to be nearer to the vehicle-body-side mount surface at the outer-surface-side end portion than at the holding-hole-side end portion in the bushing mounted state.

The separation surface may be provided on an opposite side of the particular plane from the vehicle-body-side component. The stabilizer bushing according to this form may incorporate the technical feature according to any one of the above forms (1) through (11).

### BRIEF DESCRIPTION OF THE DRAWINGS

The objects, features, advantages, and technical and industrial significance of the present disclosure will be better understood by reading the following detailed description of the embodiments, when considered in connection with the accompanying drawings, in which:

FIG. 1 is a perspective view illustrating a situation in which a stabilizer bar is mounted on a vehicle-body-side component by a bar mounting device including a bushing according to a first embodiment;

FIG. 2 is an exploded perspective view of the bar mounting device;

FIG. 3 is a cross-sectional view of the bar mounting device;

FIG. 4A is a cross-sectional view of the bushing which illustrates separation surfaces of the bushing, and FIG. 4B is a cross-sectional view of the bushing which illustrates vertical stresses acting on the respective separation surfaces;

FIG. 5 is a cross-sectional view of a bar mounting device including a bushing according to a second embodiment;

FIGS. 6A and 6B are cross-sectional views of a portion of a bushing according to a third embodiment; and

FIG. 7 is a cross-sectional view of a portion of a bushing according to a fourth embodiment.

### DETAILED DESCRIPTION OF THE EMBODIMENTS

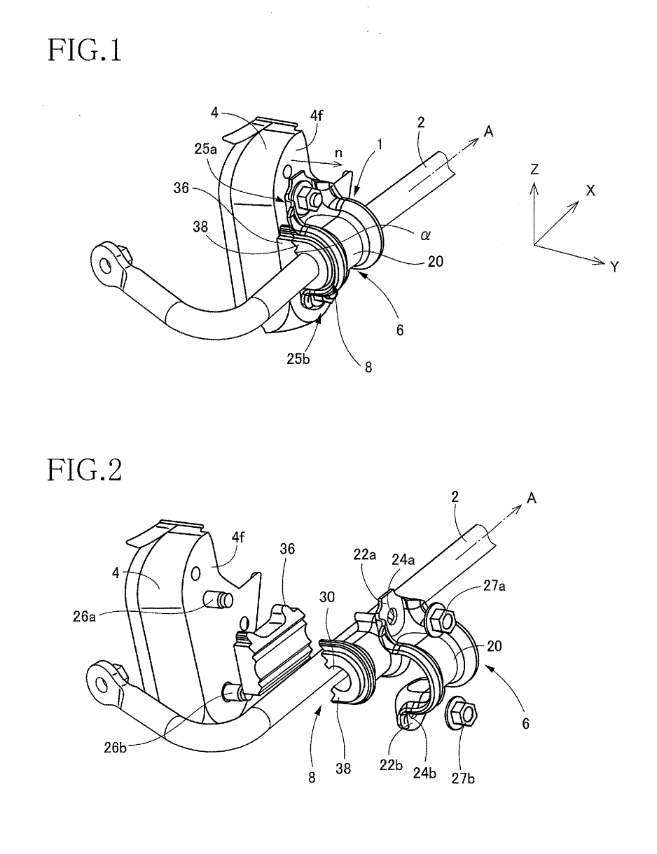

Hereinafter, there will be described a stabilizer-bar mounting device including a stabilizer bushing according to one embodiment by reference to the drawings. As illustrated in FIG. 1, the stabilizer-bar mounting device (hereinafter simply referred to as “bar mounting device”) 1 is used for mounting a stabilizer bar 2 at its torsion bar on a vehicle-body-side component 4, e.g., a suspension member. The bar mounting device 1 includes a bracket 6 and a stabilizer bushing 8 (hereinafter may be referred simply as “bushing”) according to one embodiment.

In FIG. 1, a direction parallel with an axis A of the torsion bar of the stabilizer bar 2 is defined as “X direction”. A direction parallel with a normal line n to a vehicle-body-side mount surface 4f of the vehicle-body-side component 4 is defined as “Y direction”. A direction perpendicular to the X direction and the Y direction is defined as “Z direction”. The X direction coincides with the widthwise direction of a vehicle, but each of the Y direction and the Z direction is determined depending upon a direction of the normal line n to the vehicle-body-side mount surface 4f of the vehicle-body-side component 4. In the present embodiment, the direction of the normal line n to the vehicle-body-side mount surface 4f coincides with a front and rear direction, i.e., a longitudinal direction of the vehicle, and the Z direction coincides with the up and down direction, i.e., a height direction of the vehicle.

### First Embodiment

As illustrated in FIGS. 1-3, the bracket 6 includes: a recessed portion 20 for accommodating the bushing 8; and a pair of flange portions 22a, 22b respectively provided on opposite sides of the recessed portion 20. Each of the pair of flange portions 22a, 22b is one example of a mount portion. The flange portions 22a, 22b respectively have mounting holes 24a, 24b and to be mounted on the vehicle-body-side component 4 respectively by fastening devices 25a, 25b. The fastening device 25a includes a bolt 26a and a nut 27a, and the fastening device 25b includes a bolt 26b and a nut 27b

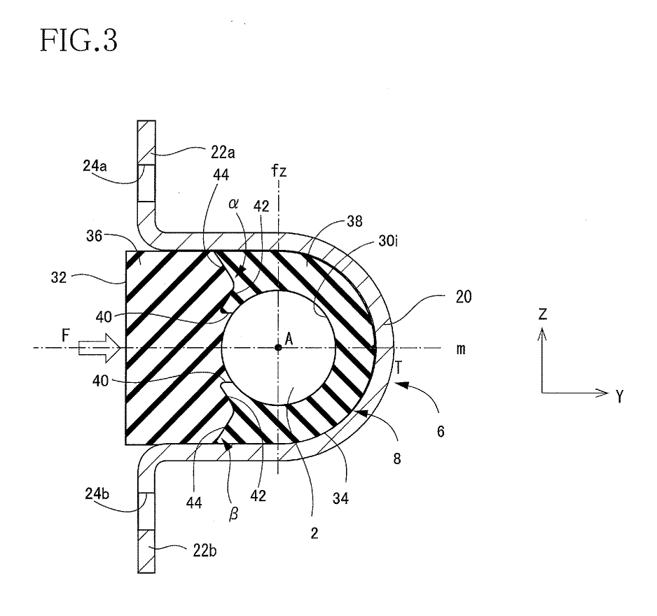

As illustrated in FIGS. 2 and 3, the bushing 8 is a tubular member formed of an elastic material such as rubber. The bushing 8 extends in a direction parallel with the axis A. The bushing 8 has (i) a holding hole 30 extending parallel with the axis A, (ii) a vehicle-body facing surface 32 that is a flat surface opposed to the vehicle-body-side mount surface 4f, and (iii) an outer surface 34 having a U shape in cross section extending in a direction perpendicular to the axis A. In the present embodiment, a central axis of the holding hole 30 (which also serves as an axis of the bushing 8) coincides with the axis A of the stabilizer bar 2.

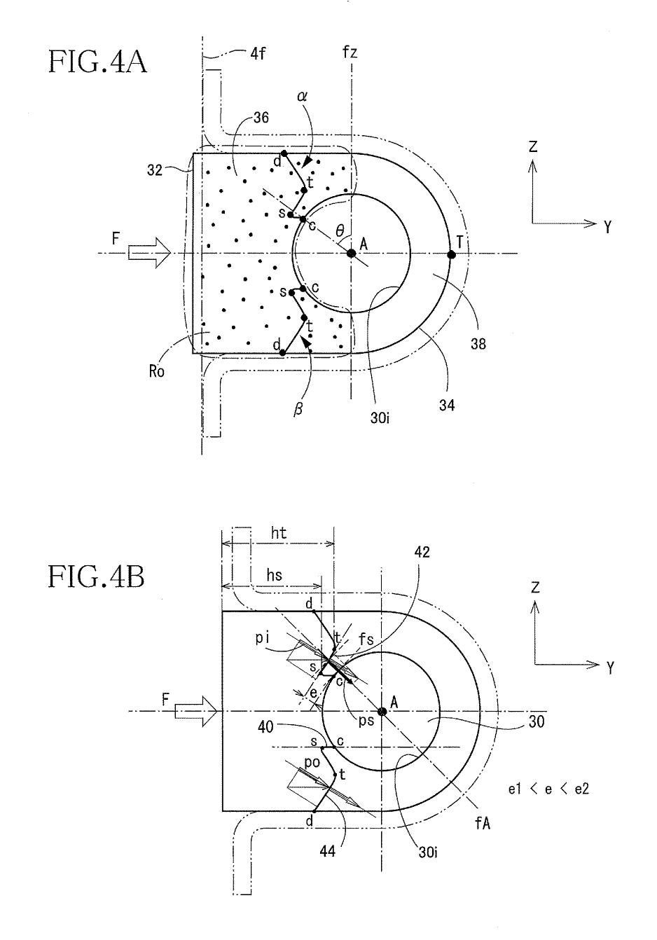

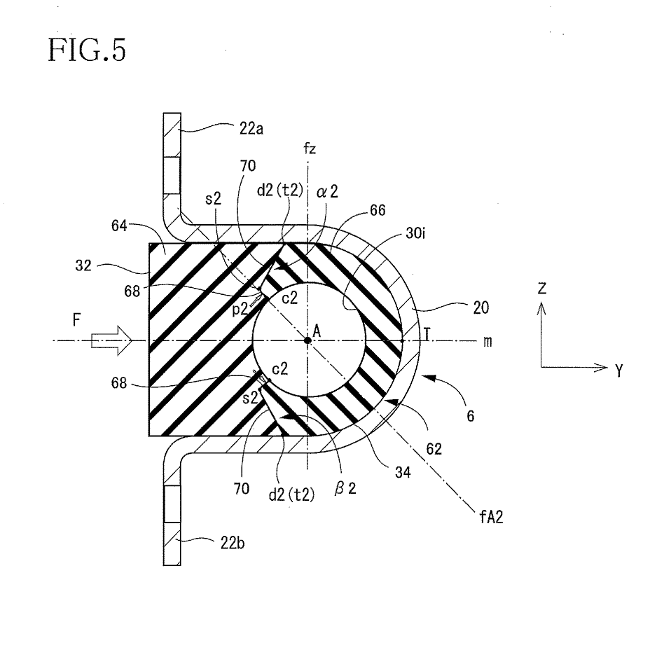

The bushing 8 includes two partial bushings 36, 38 that are shaped so as to divide the bushing 8 along separation surfaces α, β. In the present embodiment, the partial bushings 36, 38 are molded using a die. The partial bushing 36 has the vehicle-body facing surface 32, and the partial bushing 38 has a top T of the U-shaped outer surface 34. Each of the separation surfaces α, β extends over the entire length of the bushing 8 in a direction parallel with the axis A. Each of the separation surfaces α, β has one end portion c and the other end portion d. The one end portion c is located at an inner circumferential surface 30i of the holding hole 30 in which the stabilizer bar 2 is held. The other end portion d is located on the outer surface 34. Each of the separation surfaces α, β is symmetric with respect to a symmetry plane m that includes the top T of the outer surface 34 and the central axis A of the holding hole 30. There will be next explained the separation surfaces α, β with reference to FIGS. 4A and 4B.

The bushing 8 holding the stabilizer bar 2 is mounted on the vehicle-body-side mount surface 4f. This state may be hereinafter referred to as “bushing mounted state”. In this bushing mounted state, as illustrated in FIG. 4A, each of the separation surfaces α, β is provided in a portion Ro (dotted in FIG. 4A) of the bushing 8. The portion Ro is located nearer to the vehicle-body facing surface 32 than a vertical central plane fz that includes the central axis A of the holding hole 30 and that extends in the up and down direction, i.e., the Z direction.

If each of the separation surfaces α, β is provided nearer to the top T than the vertical central plane fz, it is difficult to position the partial bushing including the top T with respect to the bracket 6, which may result in deteriorated mounting accuracy. Furthermore, it is difficult to insert the partial bushing having the vehicle-body facing surface 32. In contrast, in the case where the separation surfaces α, β are provided in the portion Ro, it is possible to reduce the deterioration of accuracy of positioning of the partial bushing 38 including the top T. Also, it is possible to easily insert the partial bushing 36 having the vehicle-body facing surface 32.

As illustrated in FIGS. 3, 4A, and 4B, each of the separation surfaces α, β extends from the one end portion c to the other end portion d and has a rising surface 40, an inside pressing force generating surface 42, and an outside pressing force generating surface 44. The rising surface 40, the inside pressing force generating surface 42, and the outside pressing force generating surface 44 are different in direction of inclination with respect to the Y direction (or the Z direction). Each of these surfaces 40, 42, 44 may be curved or flat. Also, corners between the surfaces 40, 42 and between the surfaces 42, 44 may or may not be rounded.

### Inside Pressing Force Generating Surface 42

The inside pressing force generating surface 42 has end portions s, t. The end portion s is located nearer to the holding hole than the end portion t, and the end portion t is nearer to the outer surface 34 than the end portion s. The inside pressing force generating surface 42 extends from the end portion s to the end portion t. The end portion s is one example of a holding-hole-side end portion of the inside pressing force generating surface 42. The end portion t is one example of an outer-surface-side end portion of the inside pressing force generating surface 42. The inside pressing force generating surface 42 is inclined so as to be farther from the vehicle-body facing surface 32 (the vehicle-body-side mount surface 4f in the bushing mounted state) at the end portion t than at the end portion s. In other words, a distance ht between the vehicle-body facing surface 32 and the end portion t is greater than a distance hs between the vehicle-body facing surface 32 and the end portion s (ht>hs). In the case where a compressive force F that acts in the Y direction is applied to the bushing 8, as illustrated in FIG. 4B, a vertical stress pi directed toward the holding hole 30 (i.e., the stabilizer bar 2) acts on the inside pressing force generating surface 42. The vertical stress pi has a component ps directed toward the central axis A of the holding hole 30.

In the present embodiment, the vehicle-body facing surface 32 is flat. Thus, it is possible to consider that the vehicle-body facing surface 32 and the vehicle-body-side mount surface 4f are parallel with each other in the bushing mounted state. A central plane fA extends through the central axis A and a position on the inside pressing force generating surface 42. The end portion s nearer to the holding hole is located on a side of the central plane fA which is located nearer to the vehicle-body facing surface 32. The end portion t nearer to the outer surface is located on a side of the central plane fA which is located nearer to the top T.

The inside pressing force generating surface 42 is located nearer to the inner circumferential surface 30i of the holding hole 30 than the outer surface 34. The inside pressing force generating surface 42 is spaced apart from the inner circumferential surface 30i of the holding hole 30 at a distance e. The distance e is greater than a first set value e1 and less than a second set value e2 (e1<e<e2). In the case where the distance e from the inner circumferential surface 30i is less than or equal to the first set value e1, it is difficult to press the partial bushing 38 against the stabilizer bar 2 satisfactorily. In the case where the distance e is greater than or equal to the second set value e2, the vertical stress pi is absorbed by elastic deformation of the partial bushing 38, making it difficult to press the partial bushing 38 against the stabilizer bar 2 satisfactorily. In the case where the distance e is greater than the first set value e1 and less than the second set value e2, in contrast, it is possible to press the partial bushing 38 against the stabilizer bar 2 satisfactorily. Furthermore, the stabilizer bar 2 can be inserted into the partial bushing 38 more smoothly.

### Rising Surface 40

The rising surface 40 extends from the one end portion c to the end portion s in a direction substantially perpendicular to the vehicle-body facing surface 32, i.e., in a direction parallel to the Y direction. Thus, in the case where the compressive force acts on the rising surface 40 in the Y direction, a smaller vertical stress acts on the rising surface 40, making it difficult for the partial bushing 38 to be separated from the stabilizer bar 2. The one end portion c of the rising surface 40 is positioned such that a central angle between the vertical central plane fz and a plane connecting the central axis A and the one end portion c is a set angle θ (see FIG. 4A). In the case where the set angle θ is large, the area of contact between the partial bushing 38 and the stabilizer bar 2 is large. In the case where the set angle θ is small, the area of contact between the partial bushing 36 and the stabilizer bar 2 is large. In the present embodiment, the magnitude of the set angle θ is determined in consideration with adhesiveness between the stabilizer bar 2 and each of the partial bushings 36, 38.

### Outside Pressing Force Generating Surface 44

The outside pressing force generating surface 44 is located nearer to the outer surface 34 than the inside pressing force generating surface 42. The outside pressing force generating surface 44 extends from the end portion t to the other end portion d and is inclined so as to be nearer to the vehicle-body facing surface 32 at the other end portion d than at the end portion t. The end portion t is one example of a holding-hole-side end portion of the outside pressing force generating surface 44. The end portion d is one example of an outer-surface-side end portion of the outside pressing force generating surface 44. As illustrated in FIG. 4B, a vertical stress po acting on the outside pressing force generating surface 44 is directed toward the outer surface 34. Accordingly, the partial bushing 38 can be pressed against the bracket 6 well.

There will be next explained the case where the stabilizer bar 2 is mounted on the vehicle-body-side component 4 by the bar mounting device 1 constructed as described above. The stabilizer bar 2 and the partial bushing 38 are inserted into the recessed portion 20 of the bracket 6 in a state in which the stabilizer bar 2 is held by the partial bushing 38 with adhesive. The partial bushing 36 is then inserted and pressed against the stabilizer bar 2 and the partial bushing 38. In the present embodiment, the stabilizer bar 2 and the bushing 8 are bonded to each other, and the bushing 8 and the bracket 6 are bonded to each other. Thus, before the bracket 6 is fastened to the vehicle-body-side component 4, a compressive force (which may be referred to as “preload”) is applied to the partial bushing 36 in the Y direction.

Since the compressive force is applied to the partial bushing 36 in the Y direction, as illustrated in FIG. 4B, the vertical stress pi acts on the inside pressing force generating surface 42 in a direction in which the partial bushing 38 is pressed against the stabilizer bar 2. This construction makes it difficult for the partial bushing 38 to be separated from the stabilizer bar 2, thereby improving adhesiveness between the partial bushing 38 and an outer circumferential surface of the stabilizer bar 2. Also, the vertical stress po directed toward the outer surface 34 is applied to the outside pressing force generating surface 44. This construction makes it difficult for the partial bushing 38 to be separated from the bracket 6, thereby improving adhesiveness between the partial bushing 38 and the bracket 6. It is noted that the bushing 8 is compressed in the bushing mounted state, and it is difficult for the bushing 8 to be separated from the stabilizer bar 2 also in this bushing mounted state.

It is not essential to bond the bracket 6 and the bushing 8 to each other, but bonding the bracket 6 and the bushing 8 to each other can prevent ingress of foreign matters and can exhibit the function of the stabilizer bar 2 well. While the vehicle-body facing surface 32 is flat in the first embodiment, the shape of the vehicle-body facing surface 32 is not limited. For example, the vehicle-body facing surface 32 may be shaped so as to protrude toward the vehicle-body-side mount surface 4f. Also, the bushing 8 may include three or more partial bushings and may have a single separation surface, for example. Even in the case where the two partial bushings 36, 38 are not bonded to any of the stabilizer bar 2 and the bracket 6, for example, in the case where each of the partial bushings 36, 38 has a large interference in the Z direction, and a large force acts in the Y direction in the insertion of the partial bushings 36, 38 into the recessed portion 20 of the bracket 6, it is possible to make it difficult for the partial bushing 38 to be separated from the stabilizer bar 2, thereby increasing contact therebetween. Also, the separation surfaces α, β (the partial bushings 36, 38) are symmetrical with respect to the symmetry plane in the first embodiment but may be asymmetrical. The direction of the normal line n to the vehicle-body-side mount surface 4f on which the bushing 8 is to be mounted is not limited in particular. The present disclosure may be applied to a construction in which the bushing 8 is to be mounted on the vehicle-body-side mount surface 4f in a state in which the normal line n to the vehicle-body-side mount surface 4f extends in the up and down direction.

### Second Embodiment

A bushing 62 according to a second embodiment includes two partial bushings 64, 66 that are shaped so as to divide the bushing 62 along separation surfaces α2, β2. Each of the separation surfaces α2, β2 has a rising surface 68 and an inside pressing force generating surface 70 but does not have an outside pressing force generating surface.

The inside pressing force generating surface 70 has end portions s2, t2. The end portion s2 is located nearer to the holding hole than the end portion t2, and the end portion t2 is nearer to the outer surface 34 than the end portion s2. The inside pressing force generating surface 70 extends from the end portion s2 to the end portion t2. Like the inside pressing force generating surface 42 in the first embodiment, the inside pressing force generating surface 70 is inclined so as to be farther from the vehicle-body facing surface 32 at the end portion t2 than at the end portion s2. In the second embodiment, since each of the separation surfaces α2, β2 does not include the outside pressing force generating surface, the end portion t2 of the inside pressing force generating surface 70 is located on the outer surface 34, and the end portion t2 and the other end portion d2 are located at the same position.

The rising surface 68 extends from one end portion c2 to the end portion s2 substantially along a central plane fA2 that extends through the one end portion c2 and the central axis A of the holding hole 30. In the case where a compressive force in the Y direction is applied to the bushing 62, a vertical stress p2 acts on the rising surface 68 in a direction substantially parallel with a tangent to the inner circumferential surface 30i of the holding hole 30 at a position at which the inner circumferential surface 30i intersects the central plane fA2. It is possible to make it difficult for the bushing 62 to be separated from the stabilizer bar 2 when compared with the case where the vertical stress p2 acts in a direction outer than the tangent. The bushing 62 according to the second embodiment is effective on the case where the bushing 62 and the bracket 6 are not bonded to each other.

### Third Embodiment

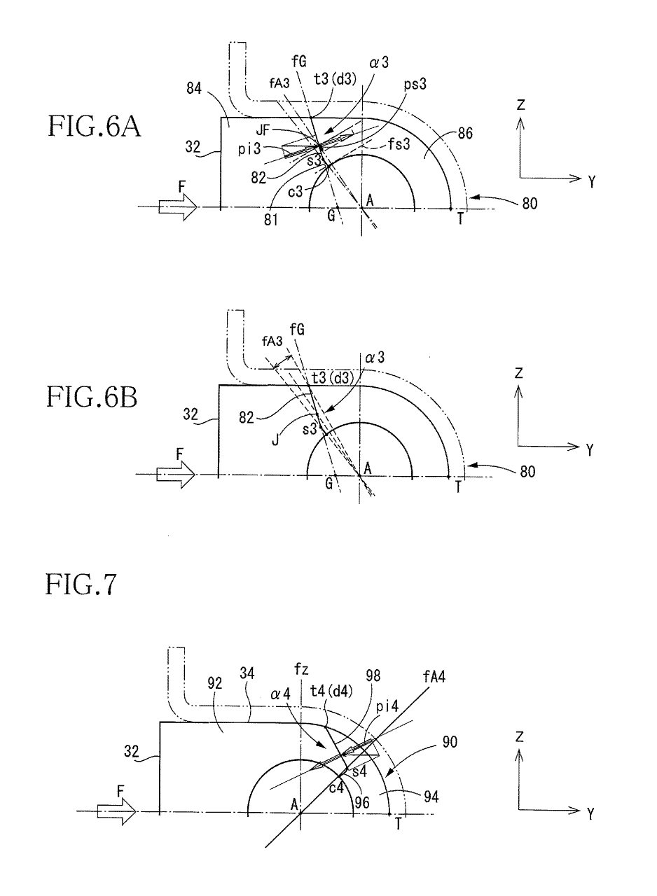

As illustrated in FIGS. 6A and 6B, a bushing 80 has separation surfaces α3, β3 (illustration of the separation surface β3 is omitted). Each of the separation surfaces α3, β3 has a rising surface 81 and an inside pressing force generating surface 82. The bushing 80 includes two partial bushings 84, 86 that are shaped so as to divide the bushing 80 along the separation surfaces α3, β3.

As illustrated in FIG. 6A, the inside pressing force generating surface 82 has one end portion s3 and the other end portion t3 (d3). The end portion s3 is located nearer to the holding hole than the end portion t3, and the end portion t3 is nearer to the outer surface 34 than the end portion s3. The inside pressing force generating surface 82 extends from the end portion s3 to the end portion t3. A central plane fA3 extends through the central axis A of the holding hole 30 and a position on the inside pressing force generating surface 82. The inside pressing force generating surface 82 is inclined in such a direction that the end portion s3 is located on a side of the central plane fA3 which is nearer to the vehicle-body facing surface 32, and the end portion t3 is located on a side of the central plane fA3 which is nearer to the top T.

A central plane extending through the central axis A and a portion J of the inside pressing force generating surface is located between the broken lines in FIG. 6B. It is apparent from FIG. 6B that the end portion s3 is located on a side of the central plane fA3 which is nearer to the vehicle-body facing surface 32 (the end portion s3 is located on the central plane fA3 or located on a side of the central plane fA3 which is nearer to the vehicle-body facing surface 32), and the end portion t3 is located on a side of the central plane fA3 which is nearer to the top T (the end portion t3 is located on the central plane fA3 or located on a side of the central plane fA3 which is nearer to the top T). Also, this inside pressing force generating surface 82 extends along a plane fG that extends through the outer surface 34 and a line G. The line G extends parallel with the axis A and located nearer to the vehicle-body facing surface 32 than the central axis A.

The rising surface 81 extends from the one end portion c3 to the end portion s3 substantially along a central plane that extends through the one end portion c3 and the central axis A.

A vertical stress pi3 acting on the inside pressing force generating surface 82 is a force directed to a side (a holding-hole side) inner than a tangent fs3 to the inner circumferential surface 30i of the holding hole 30 at a position at which the inner circumferential surface 30i intersects a central plane that extends through the central axis A and a portion of the inside pressing force generating surface 82 on which the vertical stress pi3 acts. The vertical stress pi3 has a component ps3 acting in a direction toward the central axis A. With this construction, the partial bushing 86 can be pressed against the stabilizer bar 2, making it difficult for the partial bushing 86 to be separated from the stabilizer bar 2.

The inside pressing force generating surface 82 extends toward the outer surface 34 from the end portion s3 that is spaced apart from the inner circumferential surface 30i of the holding hole 30. Thus, when compared with the construction in which the inside pressing force generating surface extends from the inner circumferential surface of the holding hole as in the dividing surface disclosed in Patent Document 1, a portion of the partial bushing 86 near the end portion s3 of the inside pressing force generating surface 82 can be pressed against the stabilizer bar 2 well, resulting in improved adhesiveness between the partial bushing 86 and the stabilizer bar 2.

### Fourth Embodiment

The separation surface may be provided in the bushing at a position nearer to the top T than the vertical central plane fz. FIG. 7 illustrates one example of this construction. A bushing 90 has separation surfaces α4, β4 (illustration of the separation surface 84 is omitted). The bushing 80 includes two partial bushings 92, 94 that are shaped so as to divide the bushing 90 along the separation surfaces α4, β4. The partial bushing 92 has the vehicle-body facing surface 32, and the partial bushing 94 has the top T.

As illustrated in FIG. 7, the separation surface a4 has a rising surface 96 and an inside pressing force generating surface 98. The inside pressing force generating surface 98 is located nearer to the top T than the vertical central plane fz. The inside pressing force generating surface 98 has one end portion s4 and the other end portion t4 (d4). The end portion s4 is located nearer to the holding hole than the end portion t4, and the end portion t4 is nearer to the outer surface 34 than the end portion s4. The inside pressing force generating surface 98 extends from the end portion s4 to the end portion t4. The inside pressing force generating surface 98 is inclined so as to be nearer to the vehicle-body facing surface 32 at the other end portion d4 than at the one end portion s4.

The rising surface 96 extends from one end portion c4 to the end portion s4 substantially along a central plane fA4 extending through the central axis A and the one end portion c4 (s4).

In the case where the compressive force F is applied, a vertical stress pi4 directed toward the holding hole 30 acts on the inside pressing force generating surface 98 against a reaction force of the compressive force F. With this construction, the partial bushing 92 can be pressed against the stabilizer bar 2. As thus described, the present disclosure may be applied to the construction in which the separation surfaces α4, β4 are provided on the portion of the bushing which is nearer to the top T than the vertical central plane fz.

While the embodiments have been described above, it is to be understood that the disclosure is not limited to the details of the illustrated embodiments, but may be embodied with various changes and modifications, which may occur to those skilled in the art, without departing from the spirit and scope of the disclosure.

What is claimed is:

1. A stabilizer bushing,
wherein the stabilizer bushing is formed with a holding hole in which the stabilizer bushing is configured to hold a stabilizer bar extending in an axial direction,
wherein the stabilizer bushing is to be mounted on a vehicle-body-side mount surface of a vehicle-body-side component,
wherein the stabilizer bushing comprises:
a vehicle-body facing surface opposed to the vehicle-body-side mount surface;
an outer surface having a U-shape in cross section perpendicular to the axial direction; and
at least one separation surface extending from an inner circumferential surface of the holding hole to the outer surface,
wherein each of the at least one separation surface comprises a pressing force generating surface located nearer to the vehicle-body facing surface than a particular plane in a bushing mounted state in which the stabilizer bushing is mounted on the vehicle-body-side mount surface,
wherein the particular plane comprising a central axis of the holding hole and is parallel with the vehicle-body-side mount surface in the bushing mounted state,
wherein the pressing force generating surface comprising a holding-hole-side end portion and an outer-surface-side end portion in the bushing mounted state,
wherein the holding-hole-side end portion is nearer to the holding hole than the outer-surface-side end portion, and the outer-surface-side end portion is nearer to the outer surface than the holding-hole-side end portion in the bushing mounted state, and
wherein the pressing force generating surface is inclined so as to be farther from the vehicle-body-side mount surface at the outer-surface-side end portion than at the holding-hole-side end portion in the bushing mounted state.

2. The stabilizer bushing according to claim 1, wherein the pressing force generating surface is located nearer to the inner circumferential surface of the holding hole than the outer surface.

3. The stabilizer bushing according to claim 1, wherein each of the at least one separation surface comprises a rising surface located nearer to the inner circumferential surface of the holding hole than the pressing force generating surface.

4. The stabilizer bushing according to claim 1,
wherein each of the at least one separation surface comprises an outside pressing force generating surface located nearer to the outer surface than an inside pressing force generating surface as the pressing force generating surface,
wherein the outside pressing force generating surface comprises a holding-hole-side end portion and an outer-surface-side end portion,
wherein the holding-hole-side end portion of the outside pressing force generating surface is nearer to the holding hole than the outer-surface-side end portion of the outside pressing force generating surface, and the outer-surface-side end portion of the outside pressing force generating surface is nearer to the outer surface than the holding-hole-side end portion of the outside pressing force generating surface, and
wherein the outside pressing force generating surface is inclined so as to be nearer to the vehicle-body-side mount surface at the outer-surface-side end portion of the outside pressing force generating surface than at the holding-hole-side end portion of the outside pressing force generating surface.

5. The stabilizer bushing according to claim 1, wherein the stabilizer bushing comprises:
two separation surfaces as the at least one separation surface; and
two partial bushings each having a shape determined by the two separation surfaces.

6. The stabilizer bushing according to claim 1, wherein the pressing force generating surface is inclined in a state in which a vertical stress having a component directed toward the central axis of the holding hole acts on the pressing force generating surface when a compressive force is applied in a direction perpendicular to the vehicle-body-side mount surface.

7. A stabilizer bushing,
wherein the stabilizer bushing is formed with a holding hole extending in an axial direction and is configured to hold a stabilizer bar in the holding hole,
wherein the stabilizer bushing is to be mounted on a vehicle-body-side mount surface of a vehicle-body-side component,
wherein the stabilizer bushing comprises at least one separation surface each extending from an inner circumferential surface of the holding hole to an outer surface of the stabilizer bushing,
wherein each of the at least one separation surface comprises a pressing force generating surface inclined in a state in which a vertical stress having a component directed toward a central axis of the holding hole acts on the pressing force generating surface when a compressive force is applied in a direction perpendicular to the vehicle-body-side mount surface in a bushing mounted state in which the stabilizer bushing is mounted on the vehicle-body-side mount surface,
wherein the pressing force generating surface comprises a holding-hole-side end portion and an outer-surface-side end portion in the bushing mounted state,
wherein the holding-hole-side end portion is nearer to the holding hole than the outer-surface-side end portion, and the outer-surface-side end portion is nearer to the outer surface than the holding-hole-side end portion in the bushing mounted state, and
wherein the holding-hole-side end portion is spaced apart from the inner circumferential surface of the holding hole.

8. The stabilizer bushing according to claim 7,
wherein a central plane extends through the central axis of the holding hole and a portion of the pressing force generating surface,
wherein the holding-hole-side end portion is located nearer to a vehicle-body facing surface of the stabilizer bushing than the central plane, and
wherein the outer-surface-side end portion is located on an opposite side of the central plane from the vehicle-body facing surface.
